(19) United States
(12) Patent Application Publication
(10) Pub. No.: US 2017/0301179 A1
(43) Pub. Date: Oct. 19, 2017

(54) LIVE ONLINE GAMING

(71) Applicant: Extreme Live Gaming Ltd, Bridgend (GB)

(72) Inventor: Darwyn Palenzuela, Bridgend (GB)

(21) Appl. No.: 15/490,112

(22) Filed: Apr. 18, 2017

(30) Foreign Application Priority Data
Apr. 18, 2016 (GB) 1606742.3

(51) Int. Cl. G07F 17/32

(52) U.S. Cl. CPC G07F 17/3223; G07F 17/3288; G07F 17/3213; G07F 17/3265; G07F 17/3276

(57) ABSTRACT

The disclosure relates to methods of, and apparatus for, online communication between a studio (401) and a plurality of remote users (404₁₋ₙ), for example in a live online gaming environment, particular examples relating to casino games such as baccarat, roulette and blackjack, in which remotely located players communicate with a live casino providing an online video feed.

### RELATED APPLICATIONS

This application claims priority to, and the benefit of, co-pending United Kingdom Patent Applications No. GB1606742.3 filed Apr. 18, 2016 for all subject matter contained in said application. The disclosure of said application is hereby incorporated by reference in its entirety.

### FIELD OF THE INVENTION

The invention relates to methods of, and apparatus for, online communication between a studio and a plurality of remote users, for example in a live online gaming environment, particular examples relating to casino games such as baccarat, roulette and blackjack, in which remotely located players communicate with a live casino providing an online video feed.

### BACKGROUND

The online gambling market represents one of the fastest growing sectors of the gambling industry. The global industry is estimated to be wroth over $417 billion, and is set to expand into new markets as regulations against online gambling are eased and its popularity grows.

A large number of online casinos are available to customers in this rapidly expanding market. The majority of online games are virtually generated, displaying entirely computer generated images to users. In such games, pseudorandom number generators are used to simulate the random chance offered in traditional “brick and mortar”, or land based casinos. However, to distinguish themselves in a crowded market, some operators offer so-called “live online casinos”.

In a live online casino, a human operator runs the game in real time from a studio. A cameral in the studio takes a view of the operator (who alternatively may be termed a dealer or croupier) and a table on which the game is played. A live video stream of the operator and table is transmitted to the remote players, who can interact with the game via their computers using various control functions provided on screen. Optical recognition technology is typically used to translate the physical actions of the game operator into data. For example, optical recognition may be used to scan cards as they are being dealt by a dealer, or to determine the final position of the ball in a game of roulette. The cards may also be provided with computer-readable information, such as a bar code, to enable an appropriately positioned reader to read each card as it is being dealt. Regulatory requirements typically prohibit the values of cards in the deck being dealt from being known before they are dealt.

Live online casinos offer several benefits to customers over conventional virtual casinos. Live casinos provide some of the look and feel of real casinos and can be marketed to mimic the more exclusive high-stakes games in real casinos. They also provide more security to the customer, since the higher running costs of a live casino mean that only the most stable casinos can operate them. Players can also have more confidence in the fairness of the live game than they can in a computer generated virtual game. The introduction of a live element can therefore be used to increase an operator's market share, as well as provide users with a more immersive and interactive experience.

However, there are high costs associated with running an online casino. A studio must be operated, and staff employed. Live online casinos therefore tend to only offer live options for more popular games which, depending on regional variations, are usually poker, roulette, blackjack and baccarat. While poker tends to be more popular in western countries such a North American countries, baccarat tends to be more popular in eastern countries such as the Philippines and other countries in eastern Asia.

It is clearly desirable to increase the number of customers using an online casino, the length of time they stay on the casino website, and the number of customers who revisit the website. One key way of achieving this is to improve the customer's experience of the online casino, to encourage return visits. In some ways this may be done by making the online casino more similar to a real casino, while in others this may be done by offering services online that cannot normally be offered in real casinos.

One of the most popular games played in live online casinos, particularly in eastern Asian countries, is baccarat. The object of baccarat is to successfully wager on whether the “banker” hand or the “player” hand will have a greater score. Each hand is a set of cards drawn from a multiple number of decks of standard playing cards. The hands are scored according to predetermined rules.

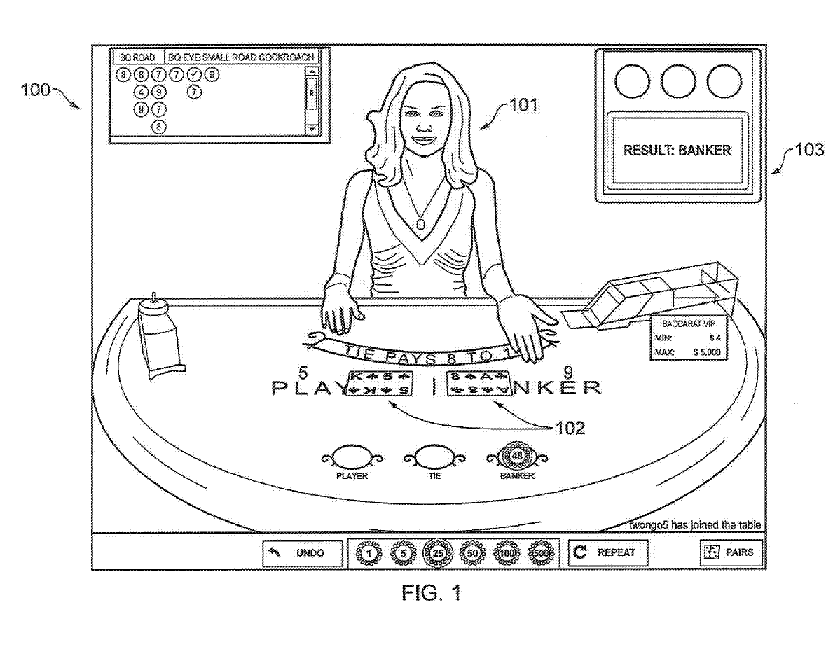

In live online casinos, baccarat is conventionally played by remote players watching a live stream of a dealer in a studio 100, as illustrated in FIG. 1. As the dealer 101 deals the cards 102, the cards 102 are turned over so that their values can be seen by the remote player via the video stream and scanned by OCR technology to translate the cards into computer readable data. The result 103 is automatically displayed on the video stream. In the example illustrated in FIG. 1, the result 103 is that the banker, scoring 9, wins over the players, scoring 5. Players can typically interact with the dealer 101 by text based messaging, or by voice feeds.

However, this manner of playing baccarat does not allow for the possibility of “squeezing” the cards, which is common in real casinos, i.e. casinos in which the operator and players are physically present in the same location around a common playing table. In real casinos, one of the players at a baccarat table may be selected to squeeze the cards. The dealer deals one of the cards face down, so that the players cannot see its value. The selected player may see a portion of the face of a card, so that the value of the card may be guessed without the other players seeing. Typically, a player is selected on the basis of highest bets in a previous round, thereby encouraging increased betting. Squeezing cards adds tension to the game, and so enhances player experience, as well as incentivising the placing of higher bets. Although it may offer the illusion of increased control to the selected player, squeezing does not affect the outcome of the game.

Squeezing has been implemented in some live online games. For example, the cards may be scanned whilst being dealt face down. The selected player then may see a computer generated video of a representation of the cards, which simulates the squeezing of a card based on the scanned value. In other systems, a pre-recorded video of cards being squeezed may be shown to the selected player. Such systems can, however, appear artificial and lack the live feeling of squeezing the cards, limiting the extent to which a player may interact with the game. There is therefore a need for a system that enables a more immersive enhanced customer experience.

As well as limiting the options for the player to interact with the game, current live systems typically limit the options available to the game operator. Particular operators may be configured to run the games in different ways. For example, the operator may wish to select a player based on a different rule in order to incentivise a particular behaviour from the players. There is therefore a need for more customisable live online casino systems.

Other popular live online casino games include roulette and blackjack. In roulette, a ball is dropped into a spinning wheel, and eventually comes to rest in a segment on the wheel. Players may bet on the segment or type of segment (for example red or black, odd or even) that the ball will come to rest on. Blackjack is a card game where a dealer deals cards to the player and to himself. The player or dealer with the highest card score, but not greater than 21, wins. Typically, the player and dealer decide whether to draw more cards to increase their score or to hold.

Live online casino versions of roulette and blackjack typically comprise a live video stream of a dealer in a casino performing the actions that would be done in a real casino. Optical recognition technology interprets the physical results of the dealer's actions, and the resulting data is transmitted to the players along with the video stream. Remote players view the live video stream of the dealer and bet accordingly. The resulting live video stream therefore has the appearance of watching a dealer in a studio, rather than providing the effect of being in a real casino, and the immersive experience is limited. It would therefore be desirable to enhance the live effect of these games, so that a more immersive experience is provided to the customer. Additionally, these games conventionally allow for little or no interactivity and do not therefore allow the operator to incentivise particular customer behaviours.

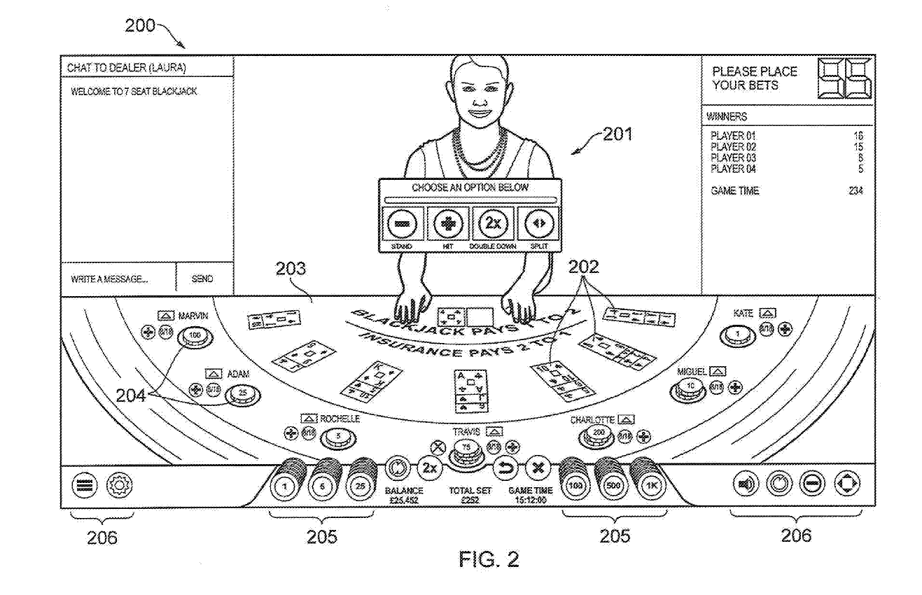

FIG. 2 shows a still image of an example video stream of a studio 200 set up for a live online game of blackjack. The dealer 201 has dealt cards 202 to seven players, each of which have allocated sections of the table 203 assigned to them. The current bets of the players are represented on overlaid images 204 at respective locations on the table 203. Each player can, at the appropriate time, place a bet by selecting one or more chips 205 from their current balance, which is displayed on screen along with their current bet. The outcome of each round is determined automatically based on automatic optical recognition of the cards being dealt, as controlled by the dealer 201. The dealer 201 therefore has only to follow a limited selection of moves, and ensure that the cards are dealt properly so as to be recognised by the automated system. One or more taskbars 206 are provided to enable the user to select various functions, such as to choose personal settings for the game.

FIG. 2 shows a still image of an example video stream 301 of a studio 300 set up for a live online roulette game. In this case, the video stream 301 is shown along with a virtual representation of a roulette board 302, which displays the current bets being placed by the players of the game. The dealer 303 operates the roulette wheel 304, and bets are taken while they are permitted before the roulette ball comes to rest. As with the game of blackjack shown in FIG. 2, the dealer 303 is permitted only to take a limited number of actions, and there is no interaction with the players of the game. The ‘live feel’ aspect of the game is therefore limited. Furthermore, the ‘types’ of betting a player can participate in are limited and, therefore, repetitive, thereby increasing the risk that a player may quickly lose interest and leave a game or site. Clearly, and as stated above, it is highly desirable to maximise the length of time a player's interest in a live online casino game can be maintained.

It is an object of the invention to address one or more of the above mentioned problems.

### SUMMARY OF THE INVENTION

In accordance with a first aspect of the invention there is provided a method of online communication between a studio and a plurality of remote users, the method comprising:

transmitting a first video stream of the studio to the remote users from a first camera in the studio;

presenting on the first video stream a first side of a card, a second side of the card being hidden;

receiving a reveal instruction sent by an instructing one of the plurality of users; and

in response to the reveal instruction, revealing a portion of the second side of the card to the instructing user in a second video stream transmitted to the instructing user from a second camera in the studio.

By allowing a user to provide an instruction to reveal an otherwise hidden portion of the card via a second video stream, the invention enables a more interactive and immersive experience for the user. Although the user cannot physically handle the card, an enhanced level of control is enabled compared to conventional methods.

A first control function enabling the instructing user to send the reveal instruction may be made available only to the instructing user. Only one of the plurality of users is allowed to perform the ‘squeezing’ action, i.e. revealing an otherwise hidden portion of the card.

Each of the plurality of users may select a bid amount prior to the card being presented on the first video stream. The instructing user can be selected from the plurality of users based on the highest bid amount from the bid amounts selected by the plurality of users, for example in a preceding round when the method involves a series of rounds.

The reveal instruction may be sent by the instructing user to indicate how much of the second side of the card is revealed on the second video stream. The reveal instruction may for example be selected from a number of options indicating varying amounts of the hidden side of the card being revealed.

A second control function may enable the instructing user to send a further instruction that is made available only to the instructing user before or after the reveal instruction is sent to the instructing user. The second control function may for example be for instructing the card to be rotated or to be passed to the dealer.

The second side of the card may be revealed to the plurality of users on the first video stream either in response to the further instruction being sent by the instructing user or after a predefined period of time has elapsed. The gameplay is therefore not held up if the user does not act for a period of time, while allowing the selected user some degree of control over how the game is played.

In accordance with the second aspect of the invention there is provided a method of online communication between a studio and a plurality of remote users, the method comprising:

transmitting a video stream of the studio to the remote users from a camera in the studio, the video stream showing a roulette wheel and a croupier;

receiving bet instructions from the plurality of users;

receiving a spin instruction sent by an instructing one of the plurality of users; and

in response to the spin instruction, spinning a ball in the roulette wheel.

An advantage of the invention is that of a more immersive experience, as the instructing user is permitted to choose when to spin the ball in the roulette wheel. The decision of when to spin is one that cannot realistically have any predictable effect on the outcome of the game, but nevertheless gives the instructing user a sense of more control over the game.

A spin control function enabling the instructing user to send the spin instruction may be made available only to the instructing user. The spin control function may be made available according to the one or more predefined rules, at random intervals or preset intervals.

The instructing user may for example be selected from the plurality of users based on a highest bid amount from previous bid instructions received from the plurality of users. The highest bid amount may be calculated over a predefined number of previous games played.

The instructing user may alternatively be selected from the plurality of users based on a number of games played by each of the plurality of users during a preceding time period, or based on a player with the highest total winnings from one or more previous games.

The instructing user may be allocated a bonus in the event of a winning bet instruction being received from the instructing user, thereby giving the plurality of users an inventive to become the instructing user. The bonus may for example be a proportion of an amount bid in the bet instruction received from the instructing user.

A predefined time period may be allowed for receiving the spin instruction. The predefined time period, which may for example be 10 seconds or less, gives the instructing user sufficient time to select the spin function, thereby giving the desired impression of control, but without holding up the game for the other users. If the predefined time period expires without a spin instruction being received, the dealer will proceed to spin the ball anyway.

In accordance with the third aspect of the invention there is provided a method of online communication between a studio and a plurality of remote users, the method comprising:

transmitting a first video stream of the studio to the plurality of remote users from a first camera in the studio, the video stream showing a table and a dealer, the table having a card dealing location for each of the plurality of remote users;

providing a cameral control function to each of the plurality of remote users;

in response to the camera control function being activated by one of the remote users, providing a second video stream to that user from a second camera in the studio, the second camera being directed to the card dealing location for that user.

An advantage of the invention is that a user can be provided with a more immersive experience, as the alternative view provided in the second video stream is more specific to the user's position on the table, thereby more closely replicating the user's view in a real casino.

The second video stream may be provided in place of the first video stream or in addition to the first video stream.

In accordance with a fourth aspect of the invention there is provided a computer program for instructing a computer, such as a network connected server, to perform the method according to any of the first to third aspects defined above. The computer program may comprise machine-readable instructions stored on a non-transitory medium such as a computer memory or storage disc.

In accordance with a fifth aspect of the invention there is provided a network server configured to perform the method according to any of the first to third aspects. The network server may be connected to the studio and the plurality of users and configured to transmit a live video stream from the studio to each of the plurality of users and to receive instructions from each of the users such as bet instructions, spin instructions relevel instructions and camera control functions in relation to a game played in the studio.

In accordance with a sixth aspect of the invention there is provided an apparatus from online communication between a studio and a plurality of remote users, the apparatus comprising a server connected via a first network connection to a studio and via second network connections to a plurality to remote users, the server being configured to:

transmit a first video stream received from a first camera in the studio to the remote users, wherein a first side of a card is presented on the first video stream, a second side of the card being hidden;

receive a reveal instruction from an instructing one of the plurality of users; and in response to the reveal instruction, transmit a second video stream the instructing user from a second camera in the studio revealing a portion of the second side of the card.

The various optional features associated with the first aspect of the invention may also be applied to the apparatus according to the sixth aspect, modified accordingly.

In accordance with a seventh aspect of the invention there is provided an apparatus for online communication between a studio and a plurality of remote users, the apparatus comprising a server connected via a first network connection to a studio and via second network connections to a plurality of remote users, the server being configured to:

transmit a video stream received from the studio to the remote users from a camera in the studio, the video stream showing a roulette wheel and a croupier;

receive bet instructions from the plurality of users;

receive a spin instruction sent by an instructing one of the plurality of users; and

in response to receiving a spin instruction, send an instruction to the studio to spin a ball in the roulette wheel.

The various optional features associated with the second aspect of the invention may also be applied to the apparatus of the seventh aspect of the invention, modified accordingly.

In accordance with the eight aspect of the invention there is provided an apparatus for online communication between a studio and a plurality of remote users, the apparatus comprising a server connected via a first network connection to a studio and via second network connections to a plurality of remote users, the server being configured to:

transmit a first video stream received from a first camera in the studio to the plurality of remote users, the video stream showing a table and a dealer, the table having a card dealing location for each of the plurality or remote users;

provide a camera control function to each of the plurality of remote users;

in response to the camera control function being activated by one of the remote users, providing a second video stream to that user from a second camera in the studio, the second camera being directed to the card dealing location for that user.

The various optional features associated with the third aspect of the invention may also be applied to the apparatus of the eighth aspect of the invention, modified accordingly.

In accordance with yet another aspect of the present invention, there is provided a computer-implemented apparatus for facilitating online communication between a studio and a plurality of remote users, the apparatus comprising:
a system clock;
a communication module configured to transmit, to remote user terminals for display on respective screens thereof, a video stream of the studio from a camera in the studio, said video stream showing a roulette wheel and a croupier;
a user interface module configured to receive first bet instructions from a plurality of user terminals; and
a processing module for displaying on a screen of one or more of said remote user terminals, together with said video stream, a plurality of graphical elements, said graphical elements having respective identity data associated therewith;

wherein said user interface module is further configured to receive a second bet instruction from said one or more of said plurality of remote user terminals in respect of a user-selected one or more of said graphical elements; the apparatus further comprising:
a win calculation module configured to receive spin data representative of at least one status of the roulette wheel during a current game and game data representative of a current game, and use said spin data and game data to calculate win data; and
a win determination module configured to compare said win data with the identity data associated with said graphical elements to determine one or more winning graphical elements, and output data representative of said one or more winning graphical elements.

Optionally, the spin data may comprise data representative of a relative rotary position of said roulette wheel during a current game, speed of rotation of said roulette wheel during a current game, position of a ball within said roulette wheel during a current game, and/or speed of rotation of a ball within said roulette wheel during a current game.

The game data may comprise time stamp data derived from a clock associated with the apparatus.

In an exemplary embodiment of the invention, the win calculation module may be configured to:
receive time stamp data derived from a clock associated with the apparatus and said spin data;
calculate first data using said time stamp data and first spin data, and calculate second data using said time stamp data and second spin data; and
calculate said win data by entering said first and second data into a random number generator algorithm.

Optionally, the first data and/or said second data may comprise a randomly generated number.

In an exemplary embodiment, the video stream of said studio may be captured with a single colour background.

The apparatus may further comprise a graphics generating module for receiving said data representative of said one or more winning graphical elements and generating graphics data representative thereof for display on a screen of one or more of said remote user terminals together with said video stream.

Optionally, the graphics data may be superimposed into said displayed video stream. The graphics data may be configured to generate an animated representation of said graphical elements. The graphics generating module may be configured to receive spin data, indicative that said roulette wheel has started to spin, and, in response thereto, trigger said animated representation of said graphical elements for display on said screen.

In an exemplary embodiment, the graphics generating module may be configured to receive spin data indicative that a current game has ended and, in response thereto, cause said animated representation of said graphical elements displayed on said screen to stop.

The graphics data may be configured to display said graphical elements in the form of one or more slot reels that spin whilst said roulette wheel is spinning and stop at the end of a current game to indicate a winning graphical element.

In accordance with another aspect of the present invention, there is provided a computer implemented method for facilitating online communication between a studio and a plurality of remote users, the method comprising:
providing a system clock;
using a communication module to transmit, to remote user terminals for display on respective screens thereof, a video stream of the studio from a camera in the studio, said video stream showing a roulette wheel and a croupier;
providing a user interface module configured to receive first bet instructions from a plurality of user terminals; and
using a processing module to display on a screen of one or more of said remote user terminals, together with said video stream, a plurality of graphical elements, said graphical elements having respective identity data associated therewith;

wherein said user interface module is further configured to receive a second bet instruction from said one or more of said plurality of remote user terminals in respect of a user-selected one or more of said graphical elements; the method further comprising:
using a win calculation module to receive spin data representative of at least one status of the roulette wheel during a current game and game data representative of a current game, and use said spin data and game data to calculate win data; and
using a win determination module to compare said win data with the identity data associated with said graphical elements to determine one or more winning graphical elements, and output data representative of said one or more winning graphical elements

It will be appreciated that any one or more of the optional features of each aspect of the present invention may be applied to any one or more of the other aspects of the invention.

### DETAILED DESCRIPTION

Aspects and embodiments of the invention are descried in further detail below by way of example and with reference to the enclosed drawings in which:

FIG. 1 is a representation of a video stream of a baccarat game in a live online casino;

FIG. 2 is a representation of a video stream of a blackjack game in a live online casino;

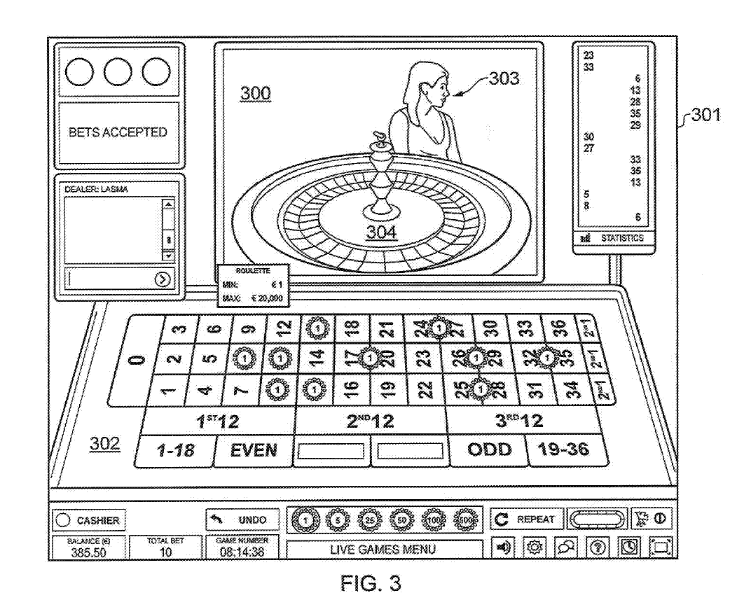

FIG. 3 is a representation of a live online game of roulette incorporating a video stream;

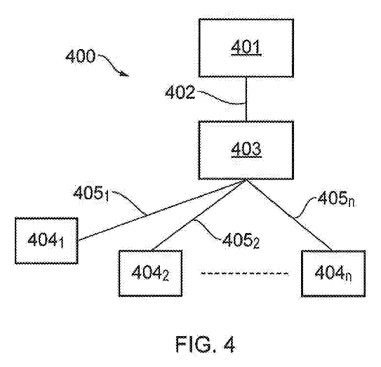

FIG. 4 is a schematic diagram of a network arrangement for a live online gaming system

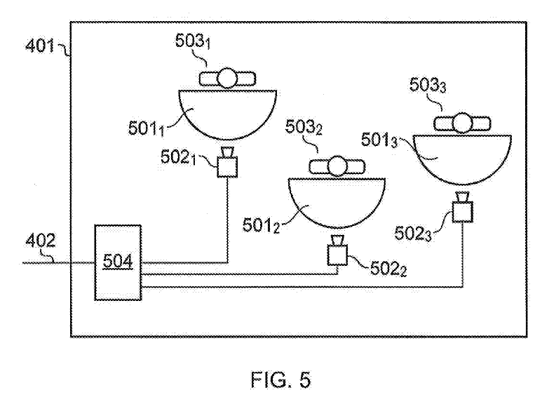

FIG. 5 is a schematic plan view diagram of an exemplary studio with a number of gaming tables and associated dealers and cameras;

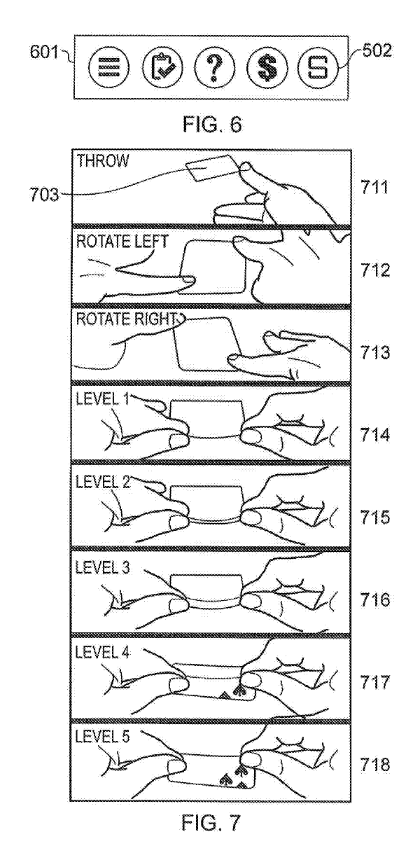

FIG. 6 is an example of a task bar comprising functions presented to a user;

FIG. 7 is an example series of illustrations of actions to be selected by a user;

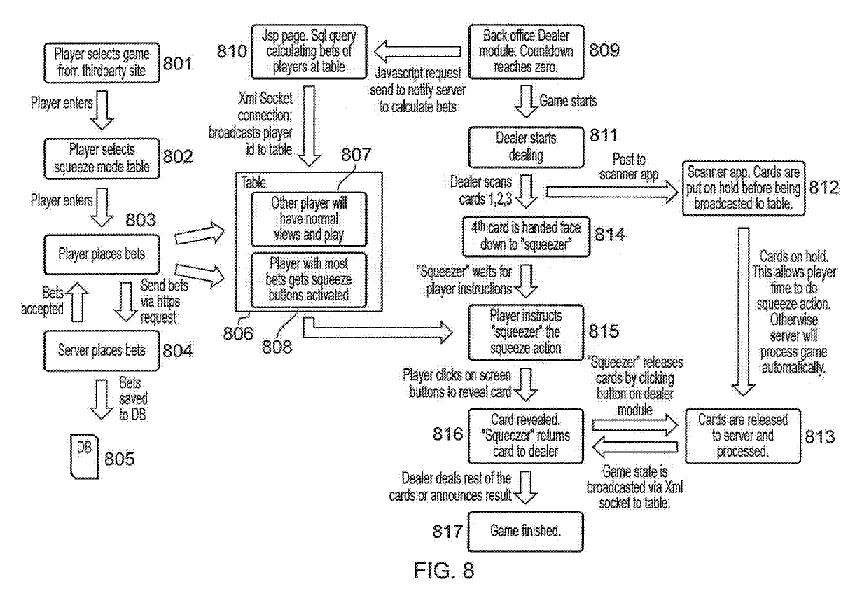

FIG. 8 is a flow chart illustrating an exemplary series of operations for a live online baccarat game;

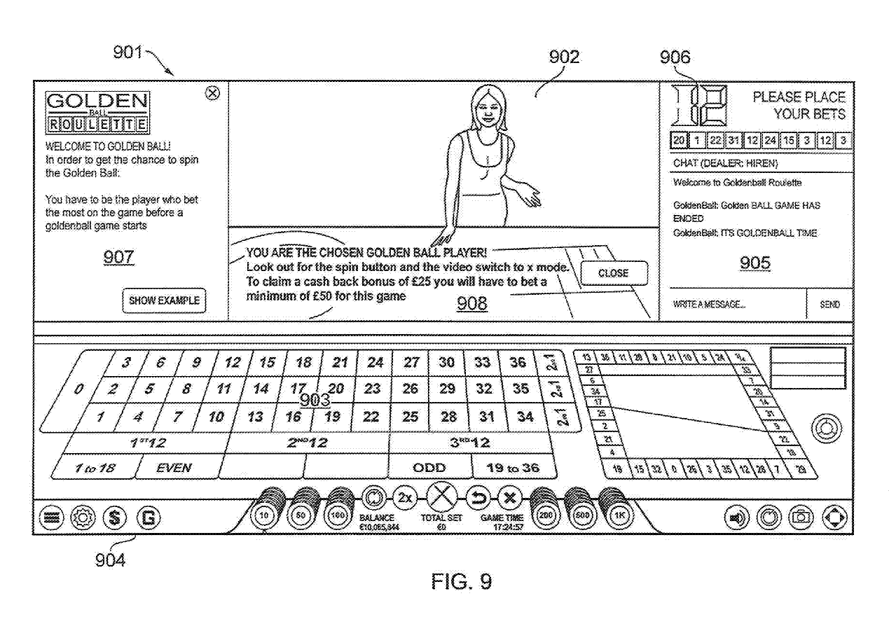

FIG. 9 is an example screen shot of a live online roulette game, as shown to an instructing user;

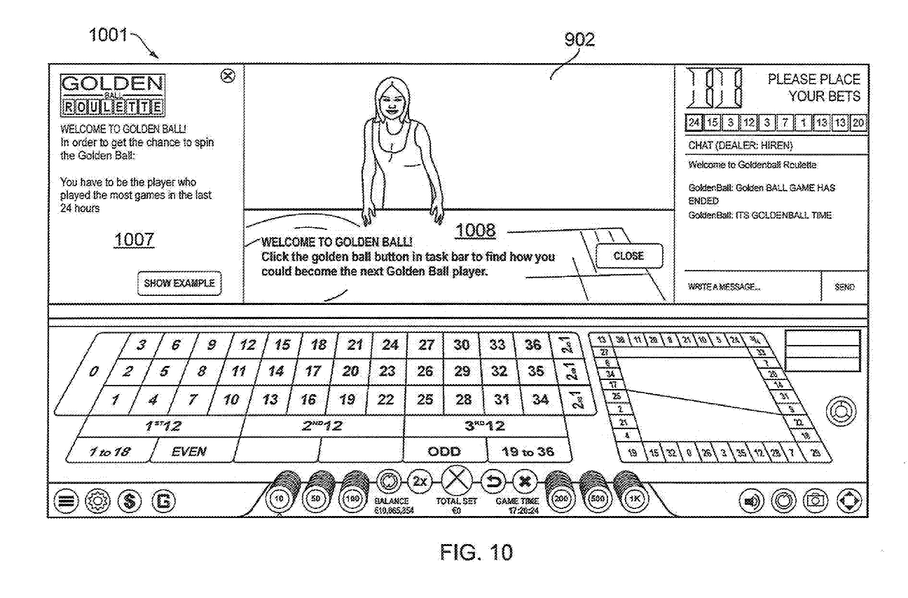

FIG. 10 is an example screen shot of a live online roulette game, as shown to a non-instructing user;

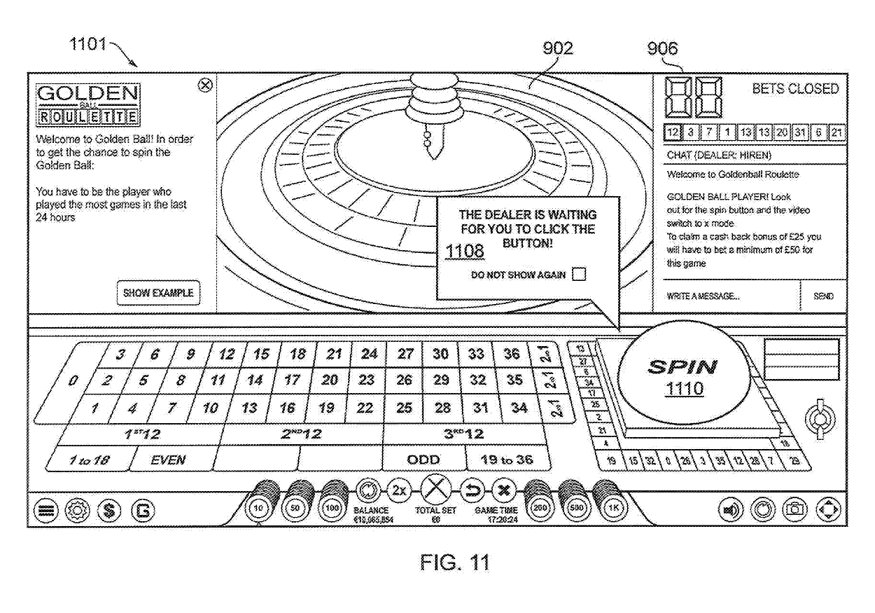

FIG. 11 is a further example screen shot of a live online roulette game, with a spin function provided to an instructing user;

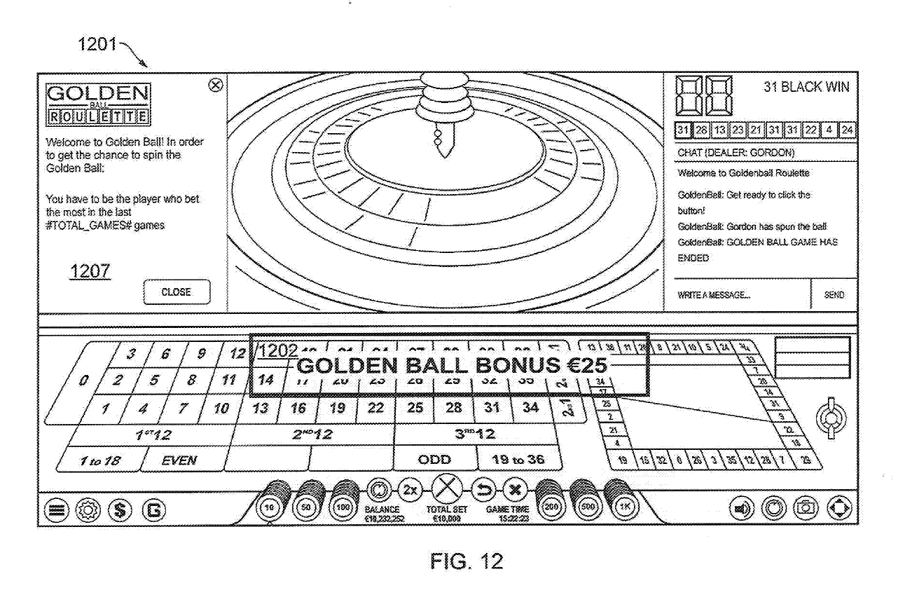

FIG. 12 is a further example screen shot of a live online roulette game, in which an instructing user is allocated a bonus following a winning bet;

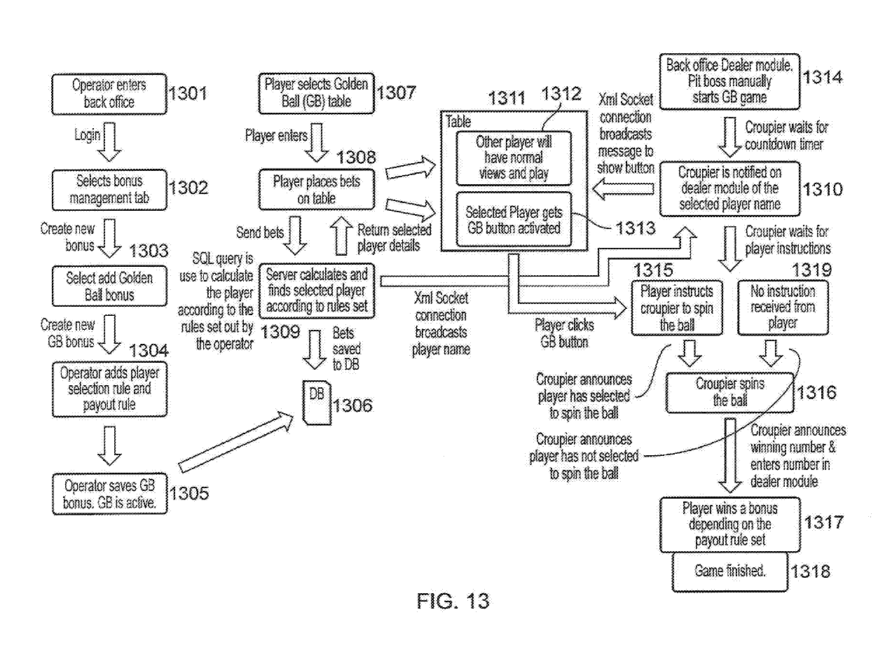

FIG. 13 is a flow chart illustrating an exemplary series of operations for a live online roulette game;

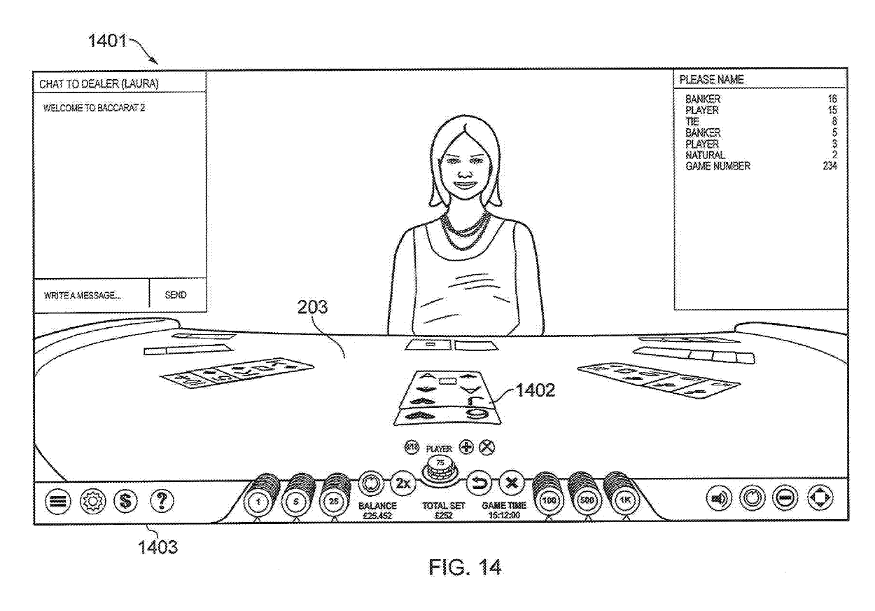

FIG. 14 is an example screen shot of an alternative video stream view to that shown in FIG. 2, as selected by a user;

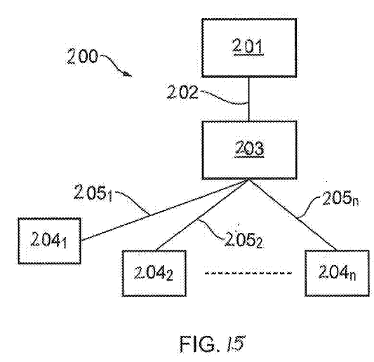

FIG. 15 is a schematic diagram of a network arrangement for a live online roulette gaming system according to an exemplary embodiment of the present invention;

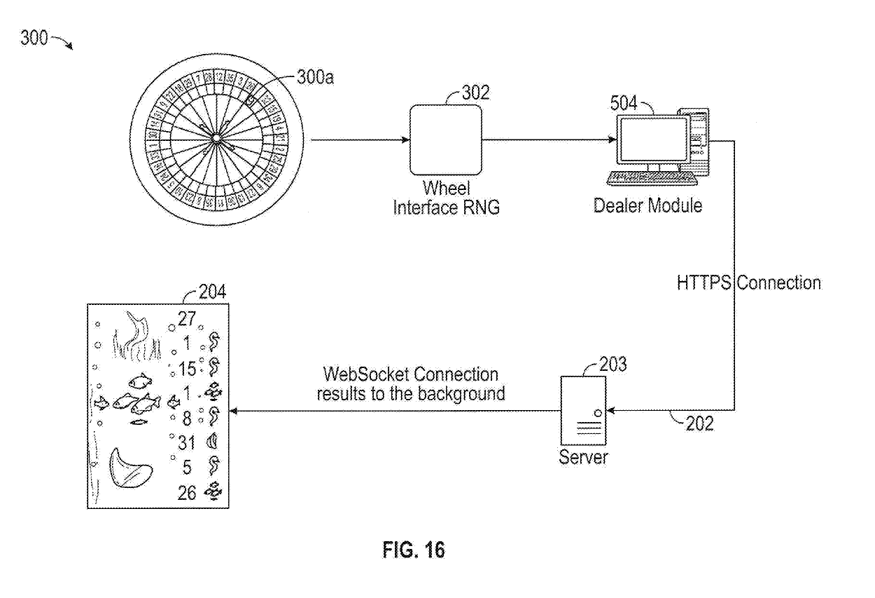

FIG. 16 is a schematic diagram illustrating the principal features of a computer-implemented apparatus for a live online roulette gaming system according to an exemplary embodiment of the present invention;

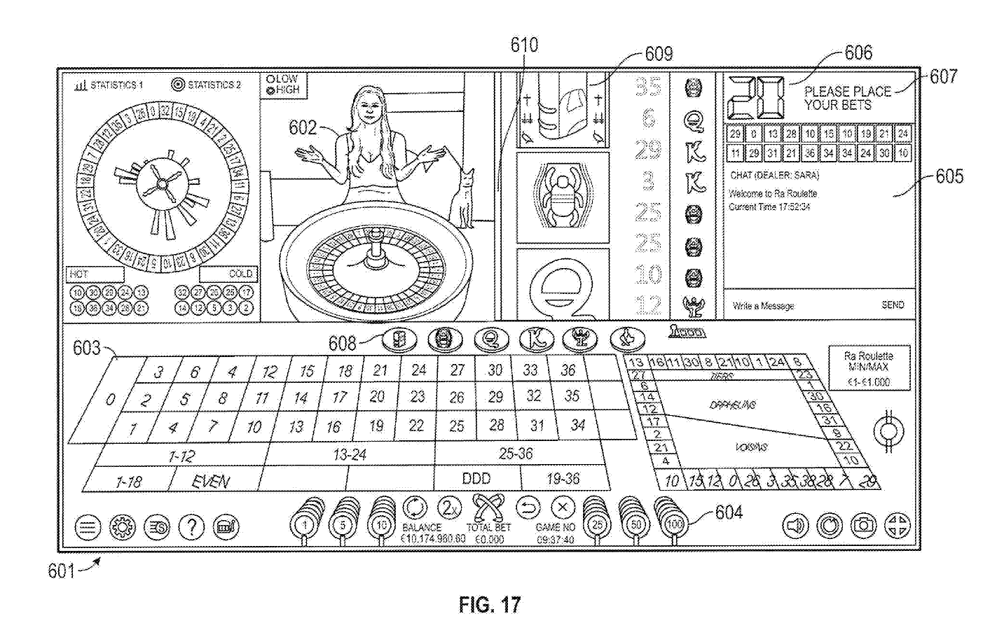

FIG. 17 is a representation of a live online game of roulette incorporating a video stream and derived using apparatus according to an exemplary embodiment of the present invention;

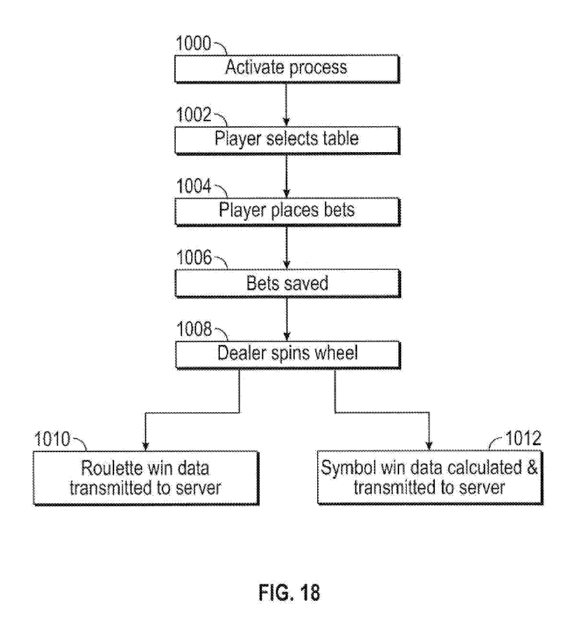

FIG. 18 is a schematic flow diagram illustrating principal steps of a computer-implemented method of facilitating a live online roulette game according to an exemplary embodiment of the present invention;

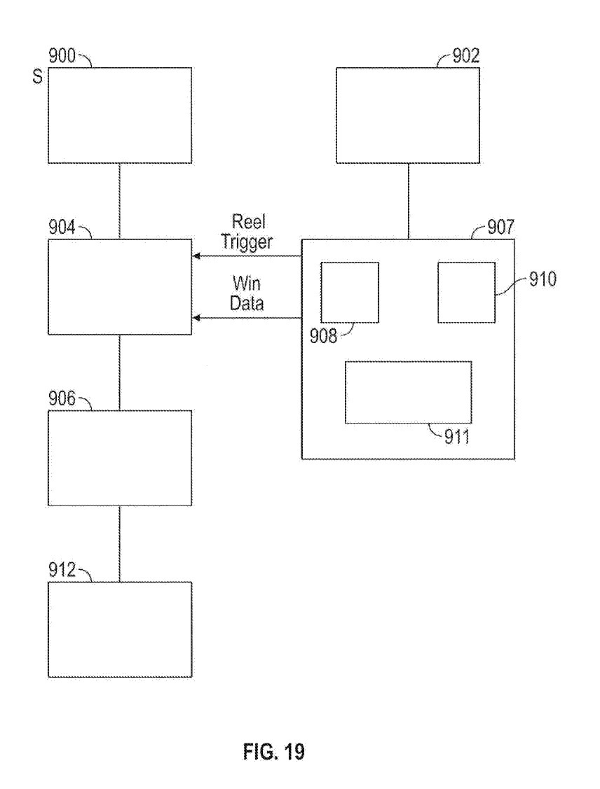

FIG. 19 is a schematic block diagram illustrating principal features of a computer-implemented apparatus for a live online roulette gaming system according to an exemplary embodiment of the present invention;

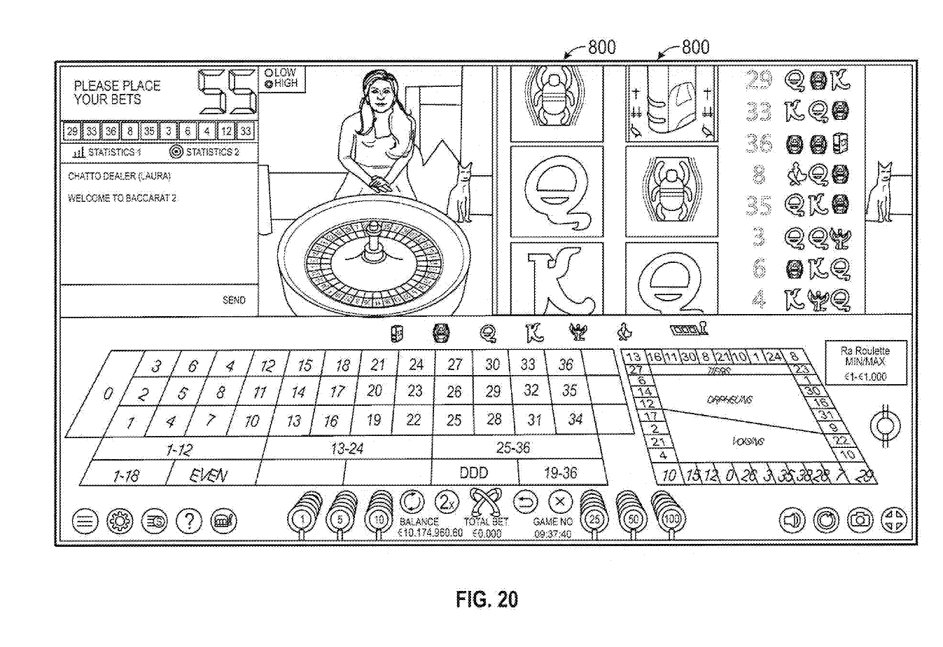

FIG. 20 is a representation of a live online game of roulette incorporating a video stream and derived using apparatus according to another exemplary embodiment of the present invention; and

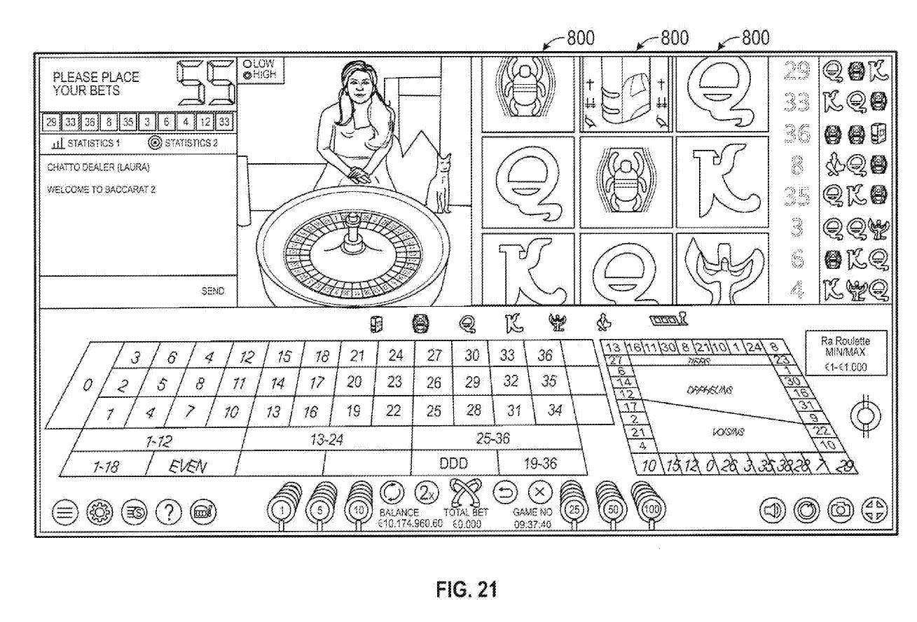

FIG. 21 is a representation of a live online game of roulette incorporating a video stream and derived using apparatus according to another exemplary embodiment of the present invention.

FIG. 4 illustrates schematically a network system 400 for live online gaming, which is applicable to each of the aspects of the invention disclosed herein. The network system 400 comprises a casino studio 401 that is linked via a first connection 402 to a server 403. The server 403 may be in a common location to the studio 401 or, more usually, may be in a different location. The location of the server 403 may be chosen depending on the expected locations(s) of the users 404₁₋ₙ, for example to minimise latency and maximise the available bandwidth for each user. While a dedicated single connection may be used for the connection 402 between the studio 401 and server 403, an effectively unlimited number of connections 405₁₋ₙ may be made between the users 404₁₋ₙ and the server 403, although in practice a maximum number of concurrent connections will be set according to the capacity of the server 403 to as to limit the possibility of the server 403 being overloaded or adversely affecting the gameplay experience of the users.

The studio 401 provides a video stream to the server 403 from one or more cameras in the studio 401, along with other data relating to the game being played, and receives from the server 403 information and instructions relating to the users 404₁₋ₙ. Each user 404₁₋ₙ is connected to the server 403 via a network connection 405₁₋ₙ, typically via the internet. The number of users in a typical live online casino game may vary from one to around seven, although can be a higher number depending on the capacity of the server 403 and the ability of the studio to accommodate the number of users in a live casino environment. The upper limit is therefore, as with real casino games, and particularly for card-based games, typically set by physical limits on the size of the table used and the time taken for a dealer to deal to all the players, which needs to be sufficiently short to maintain the users' interest. The studio 401 may accommodate more than one game at any given time, so that total number of users, n, connected to the server 403 may be considerably higher than those taking part in any single game. The bandwidth requirements on the server 403 can therefore be highly variable and large, whereas the requirements for the connection 402 between the studio 401 and the server 403 are less severe and more predictable.

FIG. 5 illustrates a schematic plan view of an exemplary studio 401 connected to a server 403 (FIG. 4) by a network connection 402. The studio 401 contains a number of gaming tables 501₁₋₃ A camera 502₁₋₃ is directed at each table 501₁₋₃ for transmitting a view of the table 501₁₋₃ and an associated dealer 503₁₋₃ to a local hub 504. The local hub 504 may be configured to send a multiplexed video stream derived from the cameras 502₁₋₃, together with associated gaming date from each table 501₁₋₃, to the server via the network connection 402. Additional overhead cameras (not shown) may be provided at each table, for example to provide a view of cards as they are being dealt for the purposes of optical recognition of the cards. Scanning equipment, such as a barcode scanner, may be provided at each table for scanning cards as they are being dealt. Data from this additional equipment is also sent to the hub 504 for onward transmission. Some local processing of the video and data feeds from the tables may be provided by the local hub 504, while other processing may be carried out remotely at the server 403 (FIG. 4).

In an exemplary implementation of the first aspect of the invention, a task bar 601 may be provided on a user's screen interface, as illustrated in FIG. 6. The task bar 601 may for example be added to a user screen interface of the types shown in FIG. 1 or 2, a typical position being along the bottom edge of the screen. The task bar 601 may provide a number of selection options for the user, such as to select personal options, a help function and a wallet function. For the particular example of a live online baccarat game, a ‘squeeze mode’ function 602 is provided on the task bar 601. The function 602 is made available to a user dependent on a predefined set of rules, and may be shown only if the function is made available. The function may otherwise be absent or greyed out and non-functional when not available. A typical rules is that the user who placed the highest bid amount in a preceding game is selected as the instructing user. Other rules may also apply, such as selecting a user at random or selecting a user based on a number of previous games played, or based on a total of bid amounts placed during a number of preceding games.

FIG. 7 illustrates a series of images that may be presented to the selected user once the function 602 is selected at the appropriate time. In baccarat, the appropriate time is generally when the fourth card has been dealt face down, at which point the function becomes available to the selected user. A predefined time period then starts, for example a period of less than 10 seconds, to allow the selected user to select the function. The images in FIG. 7 are shown to illustrate the actions that can be taken. The user may choose to throw the card 703 to the dealer (option 711), rotate the card 703 to the left or right (options 712 and 713), or reveal a portion of the hidden side of the card 703, as indicated by options 714-718. The various options 714-718 indicate different levels at which the hidden side of the card 703 can be revealed, the highest level 718 showing the largest portion of the hidden side of the card 703. A user can typically tell the value of the card 703 based on only a small portion of the card 703 being revealed, given a basic knowledge of the layout of the cards being used.

Once the function is selected and the chosen instruction is provided by the user, either the dealer of a separate designated person positioned next to the dealer performs the instructed action. A second camera is provided in the casino for the purpose of viewing the hidden side of the card, the view from which is provided as a second video stream to only the selected user. Once the view has been provided, the user may choose to throw the card to the dealer or may take no action and allow a predefined time period to elapse, after which the designated person or dealer will reveal the card to the other users.

FIG. 8 illustrates a flow diagram of an example method for performing a live online game of baccarat using the above described ‘squeeze mode’ function. From a player's perspective, the first step 801 is to select a game from a third party website. The player then selects a table (step 802), which in this case is a baccarat table with a ‘squeeze mode’ facility. When at the table, the player places bets (step 803), which are sent to the server via a secure online connection (typically via secure hypertext transfer protocol, or https, request). The bets received by the server are placed (step 804) and saved to a database 805. From the perspective of the table 806, two views are presented: a first view 807 in which a normal view of the table is presented and a second view 808 presented only to the player selected to be the instructing user for the squeeze mode, which in this example is the player with the most bets. From the perspective of a back office dealer module 809 a request is sent, for example via JavaScript, to notify the server to calculate bets. On a JavaScript (Jsp) page 810, a query (for example an SQL query) is made for calculating the bests of players at the table. Via a connection, typically an XML socket connection, the player identifications are broadcast to the table 806, which are incorporated into the views 807, 808 presented to the users. A result, the view presented to all users includes the player identifications (or IDs) together with the amounts bet.

Returning to the perspective of the dealer module, once a countdown initiated by the back office dealer module 809 reaches zero, the dealer at the table starts dealing (step 811). The dealer deals the first three cards, which are scanned as they are dealt by a scanner application (step 812). The information relating to the card values may be put on hold before being broadcast to the table, which allows time for the selected user to perform a squeeze action. Otherwise, the server will process the game automatically. Once the squeeze action is performed, or after a preset time interval, the cards are released to the server and processed (step 813). The game state is broadcast (via an XML socket connection) to the table.

From the perspective of the player selected to be the instructing user, once the fourth card is handed face down to the ‘squeezer’ (step 814), the squeezer waits for instructions from the instructing user. The instructing user instructs the squeezer to perform a squeezing action (step 815) and a portion of the card is revealed to the instructing user (step 816). The instructing user then releases the cards by clicking on a selection option, or after a predetermined time delay, the cards are released and shown to the other players. The dealer then announces the result and the game ends (step 817).

FIG. 9 shows an exemplary screen 901, i.e. from a user's perspective, of a live online game of roulette. The screen 901 comprises a live video stream 902, a representation of a layout (or betting area) 903 and a taskbar 904 containing various information and control functions specific to the user. Other portions of the screen 901 may be used to contain information displays such as a chat function window 905, a timer 906 and an announcement window 907. A further overlaid information window 908 is shown to the user to indicate that they have been selected to be an instructing user for the particular game. In the example shown, the instructing user is nominated to be the chosen ‘golden ball’ player, and is informed that they should look out for a spin button and for the video steam to switch to an ‘x’ (or interactive) mode. A cash back bonus may also be indicated, which in this case is dependent on the user placing a minimum bet for the game. In the example shown, the cash back bonus is −25, for a minimum bet of −50.

A different screen 1001 is shown to other users, or players, taking part in the same game, as shown in FIG. 10. Most of the features of the screen 1001 are the same as those for the instructing user, but in this case the information window 1008 indicates that the user may become a golden ball player. The information window 1007 indicates the requirements for becoming a golden ball player, which is to be the player who played the most games in the last 24 hours. Other rules may apply, for example based on the highest previous bet, a random selection or on highest total winnings.

Returning to the instructing user's screen, FIG. 11 shows a subsequent screen 1101 once the timer 906 indicates that bets are closed. The video stream window 902 now switches to a view of the roulette wheel. An overlaid information window 1108 is displayed to indicate that the user now has an opportunity to send a spin instruction, which in this example is provided by clicking on a golden ball 1110 marked ‘spin’. If the user clicks on the ball 1101 within a predefined time period (which may, for example be less then 10 seconds), an instruction is sent to the studio for the dealer to spin the ball in the roulette wheel. Alternatively, the ball may be spun (i.e. projected along the outer circumference of the roulette wheel) by a ball ejection machine configured to project the ball upon receiving a trigger signal initiated by the user clicking on the ball. To improve the user experience, the latency of action, i.e. the time between the user clicking on the ball 1110 and the ball being projected, is preferably as short as possible, for example less than one second. A machine-operated ball projector may therefore be preferred, although in other cases a dealer may manually project the ball into the roulette wheel, which may be necessary due to regulatory requirements.

The principle of the golden ball option is that only the instructing user is given the option to spin the ball. This should have no effect, or at least no predictable effect, on the outcome of the game. A user may nevertheless obtain an improved experience from the option, since the impression is given that they have some control over the game. This may be sufficient for a user to want to be the golden ball player, and may therefore incentivise the user to meet the state requirements, for example being the player who played the most games in a preceding time period. The effect of this would be to increase the amount of time the user plays. The rule may alternatively be the highest amount bet over a preceding number of games or the player with the highest total winnings from a preceding number of games. Allocating a bonus payment in the event of a win when a player is a golden ball player provides a further inventive to become the golden ball player. The bonus is typically a portion of the amount bid in the bet instruction provided by the golden ball player for that game, rather than a proportion of the winning amount, so as to incentivise the player based on how much they bet rather than how much they win (which is entirely out of their control).

FIG. 12 shows a subsequent screen 1201 shown to the golden ball player following placement of a winning bet. An information window 1202 is shown indicating that a golden ball bonus payment has been made, which in this case is [symbol] 25 from a [symbol] 50 bet. The golden ball selection process then restarts, and a golden ball player is selected once a subsequent game commences. The prevent the same player from being selected each time, the rule chosen for selecting the instructing player may be altered for a subsequent game. In the example shown in FIG. 12, once the game has ended the information window 1207 changes to indicate that the player who bet the most over a preceding number of games is selected to be the golden ball player.

FIG. 13 is a flow diagram illustrating a sequence of steps taken for the above process. From the operator point of view, the process starts with the operator entering, i.e. logging into, the back office program (step 1301). The operator selects a bonus management facility, which may be available via a tab selection (step 1302), and chooses to add a golden ball bonus (step 1303). The operator then adds the player selection rule and a payout rule (step 1304), if applicable. The operator saves the selections, and the process is then active (step 1305). The settings are stored in a server database 1306.

From a player's point of view, the process starts with the player selecting a golden ball table (step 1307). The player then places bets on the table (step 1308), which are sent to the server. The server calculates the bets and finds a selected player according to the rules set by the operator (step 1309), and saves the bets in the database 1306. An SQL query, for example, may be used to calculate the player according to rules set by the operator. An XML socket connection is used to broadcast the selected player name and the croupier is notified on a dealer module of the selected player name (step 1310).

From the perspective of the screen shown to the players, the table 1311 is shown in two modes. In a first normal mode 1312 players have normal views and play, while in a second mode 1313 the selected player has the golden ball button activated.

From the perspective of the back office dealer module, the process begins by the pit boss (i.e. a supervisor of a number of gaming tables) manually starting a golden ball game (step 1314). The croupier at each table waits for a countdown timer 906 (FIG. 9) to expire, and is notified of the selected player name (step 1310), while an XML socket connection is made to broadcast a message to show the golden ball button to the selected player. The croupier waits to receive a spin instruction from the instructing user (the golden ball player), resulting in one of two possible outcomes. In a first outcome 1315, the player provides a spin instruction and the croupier announces that the player has selected to spin the ball. The croupier then spins the ball (step 1316). In a second outcome, where no instruction is received from the instructing user (step 1319), the croupier announces that the golden ball player has not selected to spin the ball, and proceeds to spin the ball (step 1316). The croupier then announces the winning number and this is entered into the dealer module. The player then wins a bonus depending on any payout rule that may have been set by the operator (step 1317). The game then finishes (step 1318), and the process then repeats, starting again from step 1314.

FIG. 14 shows a screen 1401 as presented to a user, or player, for a live online gam of blackjack, in which a second video stream to show a perspective from the user's position on the table 203 is shown. In comparison to the normal view of the table 203 shown in FIG. 2, the view in FIG. 14 is closer to the table and more representative of the view that the user would have if they were seated at that position. The player's cards 1402 are presented directly in front of the player, in the centre of their screen, thereby emphasising their position in the game and enhancing the player's experience of the game by more closely simulating a real casino experience. The player may choose to switch between the two views represented by FIG. 2 and FIG. 14 by selecting a camera control function on their task bar 1403. The alternative camera view may be provided for all active players in the game, and is enabled by having multiple cameras placed around the periphery of the table 203 at or near a position similar to that a user would take if seated at a real table.

In each of the embodiments disclosed herein, two-way video communication may be enabled by video streams being sent from cameras located at the remote users' locations. These video streams may be received by the server and incorporated into the video stream that is sent to all users and/or may be viewable by the dealer. In the example of a blackjack game with alternative camera views, the alternative camera view may be a composite view of the image of the table together with views of each of the other players located at their respective positions. Each user may be provided with an option to rotate the alternative camera view so that their view of the table may be changed. A scaling and mapping operation may be carried out on each video stream received from the players so that their appearance within the video stream is correctly oriented to appear to be positioned around the table, thereby simulating their appearance on a virtual video screen around the table.

FIG. 15 illustrates schematically a network system 200 for live online gaming according to an exemplary embodiment of the present invention, which is applicable to each of the aspects of the present invention disclosed herein. The network system 200 comprises a casino studio 201 (including a dealer module) that is linked via a first connection 202 to a server 203. The server 203 may be in a common location to the studio 201 or, more usually, may be in a different location. The location of the server 203 may be chosen depending on the expected location(s) of the users 204₁₋ₙ for example to minimise latency and maximise the available bandwidth for each user. While a dedicated single connection may be used for the connection 202 between the studio 201 and the server 203, an effectively unlimited number of connections 205₁₋ₙ may be made between the users 204₁₋ₙ and the server 203, although in practice a maximum number of concurrent connections will be set according to the capacity of the server 203 so as to limit the possibility of the server 203 being overloaded or adversely affecting the gameplay experience of the users.

The studio 201 provides a video stream to the server 203 from one or more cameras in the studio 201, along with other data relating to the game to be played, and receives from the server 203 information and instructions relating to the users 204₁₋ₙ. Each user 204₁₋ₙ is connected to the server 203 via a network connection 205₁₋ₙ typically via the internet. The number of users in a typical live online casino game may vary from one to around seven, although can be a higher number depending on the capacity of the server 203 and the ability of the studio to accommodate the number of users in a live casino environment. The studio 201 may accommodate more than one game at any given time, so the total number of users n connected to the server 203 may be considerably higher than those taking part in a single game. The bandwidth requirements on the server 203 can therefore be highly variable and large, whereas the requirements for the connection 202 between the studio and the server 203 are less severe and more predictable.

As previously described, FIG. 5 illustrates a schematic plan view of an exemplary studio 201 connected to a server 203 (FIG. 15) by a network connection 202. The studio 201 contains a number of gaming tables 501₁₋₃. A respective camera 502₁₋₃ is directed at each table 501₁₋₃ for transmitting a view of the table and an associated dealer 503₁₋₃ to the local hub or dealer module 504. The dealer module 504 may be configured to send a multiplexed video stream derived from the cameras 502₁₋₃ together with associated gaming data from each table 501₁₋₃ to the server via the network connection 202. Additional overhead cameras (not shown) may be provided at each table, for example to provide a view of the roulette wheel as it is being spun for the purposes of optical recognition of the rotary position of the wheel and the location therein of the ball after it has been spun. Data from this additional equipment is also sent to the dealer module 504 for onward transmission. Some local processing of the video and data feeds from the tables may be provided by the dealer module 504, while other processing may be carried out remotely at the server 203 (FIG. 15).

The background provided in the studio 201 for the tables 501 and dealers 503 is preferably of a single colour, typically blue or green, such that the cameras 502₁₋₃ capture a video stream with a single colour backdrop. A graphics module (not shown) associated with the dealer module 504 or the server 203 (FIG. 15) can generate graphics data (still or animated) and an editing module (not shown) utilising Green Screen technology enables the above-mentioned single colour to be made transparent such that the generated graphics can be superimposed into the video stream displayed at the remote user terminals.

Referring to FIG. 16 of the drawings, a wheel interface module 302 may be provided in respect of the roulette wheel 300. As will be well known to a person skilled in the art., a roulette wheel 300 has a rotor with pockets on the periphery of the rotor. In some known roulette wheel systems, sensors are provided to detect the ball. These sensors may be provided on the rim of the wheel (to detect the ball in the ball track) and at least one sensor may be provided to detect which pocket the ball lands in, although this sensing may additionally or alternatively be performed by the aforementioned overhead cameras and an associated optical recognition module. The sensors detect a number of different pieces of spin data (or ‘game state data’), including the number of the pocket in which the ball falls for each game, the speed of the rotor, the speed of the ball, relative rotary position of the rotor, etc. A processor is provided in the wheel interface module 302 for receiving this game state data and configured to generate two bonus numbers using game state data of the aforementioned type as well as time stamp data associated with a specific (current) game. For example, a first bonus number may be calculated using time stamp data and wheel speed data or rotary position data, and a second bonus number may be calculated using time stamp data, wheel speed/position data and ball speed/position data. Irrespective of the game state data used to generate the first and second bonus numbers, it will be appreciated that each bonus number is essentially a random number generated in respect of a specific current game, and a wheel interface module capable of performing this process is known from, for example, US2011/0244939. Once generated, the two bonus numbers are entered into an algorithm to generate a number (e.g. between 0 and 126, wherein the generated number is indicative of a “winning” symbol (as will be explained in more detail below). The generated number, or data representative of the winning symbol, is fed to the dealer module 504. This ‘win’ data may be processed at the dealer module 504, or transmitted to the server (via HTTPS connection 202) for processing, to generate suitable graphics data for transmission to the relevant remote user terminal(s) 204 to be superimposed into the displayed video stream.

Furthermore, the wheel interface module is configured to identify (via the sensors) when the wheel starts to spin, and output data indicative of this. This data is transmitted to the dealer module and processed to generate animation data to animate the graphics superimposed into the displayed video stream, as will be explained in detail hereinafter.

FIG. 17 shows an exemplary screen 601, i.e. from a user's perspective, of a live online game of roulette. The screen 601 comprises a live video stream 602, a representation of a layout (or betting area) 603 and a taskbar 604 containing various information and control functions specific to the user. Other portions of the screen 601 may be used to contain information displays such as a chat function window 605, a timer 606 and an announcement window 607. The task bar 604 may provide a number of selection options for the user, such as a help function, a wallet function and a facility to enable the user select personal options. For example, in this particular exemplary embodiment of the present invention, a set of seven graphical symbols 608 are laid out horizontally, in side-by-side configuration, along the top of the betting area 603. These symbols 608 are user-selectable within the betting area 603, and bets may be placed thereon. Thus, the user can select one or more of the symbols 608, and place a bet thereon that it will be the winning symbol after the roulette wheel has been spun. In the exemplary embodiment illustrated in FIG. 6, the same symbols are displayed on the screen in the form of a reel 609, defined by computer-generated graphics and made to look similar to a reel of a conventional ‘fruit machine’ in the sense that it can be animated to appear to ‘spin’ about a horizontal axis whilst the roulette wheel is spinning triggered by the above-mentioned data from the wheel interface module indicative that the roulette wheel has started spinning), with the various symbols appearing within the user's perspective as the reel spins. A ‘marker’ 610 is provided in respect of the reel 609, corresponding to a central portion of the visible part of the reel, which marks the “winning” symbol after the roulette wheel has been spun and the winning symbol has been calculated and determined in the manner described above.

Thus, in use, referring to FIG. 18 of the drawings and starting with the dealer's point of view, a method according to an exemplary embodiment of the present invention starts with the operator entering, i.e. logging into, the back office program (step 1000) facilitated by the dealer module referenced above. Once the process is active, the game can be accessed online by remote users or players.

From the player's point of view, the process starts with the player selecting a table (step 1002). The player then places the bets on the table (step 1004), which are sent to the server. The server calculates the bets and saves the bets in a database within, or communicably coupled to the dealer module (step 1006). At this stage, the player can also place a bet on one or more of the symbols 608 (FIG. 5) the corresponding bet(s) are also saved to the database.

Next, the dealer spins the roulette wheel (with the ball), either in response to a selected remote user's instruction or upon the expiry of a predetermined period of time (e.g. at the end of a countdown timer to indicate that the betting period has expired) (step 1008). The video stream window 602 (FIG. 5) may then switch to a view of the roulette wheel as it spins and until it stops, thereby showing the remote user where the ball has landed when the wheel stops. The dealer announces the winning ball position and data representative thereof is transmitted, via the dealer module, to the server to be displayed on the remote user(s) screens (step 1010). In addition, the aforementioned bonus numbers and, therewith, a winning number is generated that corresponds to a winning symbol (step 1012). Data representative of the winning symbol can be used to derive graphics data for display at the remote user terminal to indicate the winning symbol. In this exemplary embodiment of the present invention, that data is used to cause the ‘reel’ carrying the symbols to stop spinning at a point wherein the winning symbol is located generally centrally and in line with the marker to indicate that it is the winning symbol.

This process can be seen more clearly in FIG. 19, which illustrates schematically the technical aspects of the win determination and display process. Thus, whilst the roulette wheel is spinning, the video stream is shot by the first one or more (‘head on’) cameras 900 in the studio, and overhead images are captured by the second one or more (overhead) cameras 902. The video stream is transmitted, via the dealer module 904, to the server 906 for display in the video stream window of a remote user's screen. The image data from the overhead camera(s) 902 (or wheel data from the wheel sensors, not shown) is transmitted to a wheel interface module 907. Within the wheel interface module 907, there is provided a processor 908, an optical recognition and/or sensor module 910, and a random number generator (RNG) module 911. The images from the overhead camera(s) 902 and/or or the signals from the wheel sensors are processed by the optical recognition module 910 (or data obtained from the sensors is processed by a sensor module 910) to determine the above-mentioned spin data. Data indicative that the wheel has started spinning is transmitted, via the dealer module, to the server to trigger animation (i.e. spinning) of the displayed slot reel(s) carrying the bonus symbols. Time stamp data for that specific spin is also determined by the wheel interface module. The time stamp data and the spin data are fed to the processor 908. The processor is configured to use a first algorithm to generate a first bonus number using the time stamp data and first spin data, and a second algorithm to generate a second bonus number using the time stamp data and second spin data. The first and second bonus numbers, or data representative thereof, are fed to the random number generator module 911 which generates a number therefrom (e.g. between 0 and 126) and outputs the generated number to the processor. The winning symbol is determined according to the generated number, and data representative thereof is a) transmitted for display at the remote user's terminal 912 and b) used to calculate the remote user's winnings (using bet data held in a database within, or communicably coupled to, the server 906). Win data is then also transmitted for display at the remote user's terminal. Furthermore, spin data (generated when the ball lands on a number and has rotated at least twice in the wheel) is generated by the wheel interface module and used (in addition to the win data) to stop the graphics reel(s) at the correct position to display the winning symbol. It will be appreciated that, whilst the processor, random number generator module and image recognition module have been illustrated in FIG. 19 as separate entities within the wheel interface module, one or more of these functions may be integrated as a single module. Equally, these functions may not be provided within a so-called wheel interface module: one or more of the functions may be provided within the dealer module, in the server or even remotely from both the server and the dealer module, and the present invention is not necessarily intended to be in any way limited in this regard.

Referring now to FIG. 20 of the drawings, in another exemplary embodiment of the present invention, the user display may be provided with a pair of reels 800, each carrying symbols on their ‘outer’ rim. The reels may be positioned on the user's screen in side-by-side configuration and arranged to “spin” about the same horizontal axis (triggered by the above-mentioned data indicative that the roulette wheel has started to spin). In this case, a symbol “win” may comprise a combination of two symbols (as indicated by the winning combination of symbols appearing side by side against the marker) and the winning number generated in the manner described above may correspond to a winning combination of symbols, rather than a single symbol. Referring to FIG. 21 of the drawings, in yet another exemplary embodiment of the invention, three reels 800 of symbols may be provided, in side-by-side relation and a symbol win may comprise a combination of three symbols, such that the above-mentioned winning number corresponds to a winning combination to be indicated to the user by the row of three symbols appearing against the marker when the reels stop spinning.

Other embodiments are within the scope of the invention, which is defined by the appended claims.

1. A computer-implemented apparatus for facilitating online communication between a studio and a plurality of remote users, the apparatus comprising:
a system clock;
a communication module configured to transmit, to remote user terminals for display on respective screens thereof, a video stream of the studio from a camera in the studio, said video stream showing a roulette wheel and a croupier;
a user interface module configured to receive first bet instructions from a plurality of user terminals; and
a processing module for displaying on a screen of one or more of said remote user terminals, together with said video stream, a plurality of graphical elements, said graphical elements having respective identity data associated therewith;
wherein said user interface module is further configured to receive a second bet instruction from said one or more of said plurality of remote user terminals in respect of a user-selected one or more of said graphical elements; the apparatus further comprising:
a win calculation module configured to receive spin data representative of at least one status of the roulette wheel during a current game and game data representative of a current game, and use said spin data and game data to calculate win data; and
a win determination module configured to compare said win data with the identity data associated with said graphical elements to determine one or more winning graphical elements, and output data representative of said one or more winning graphical elements.

2. Apparatus according to claim 1, wherein said spin data comprises data representative of a relative rotary position of said roulette wheel during a current game, speed of rotation of said roulette wheel during a current game, position of a ball within said roulette wheel during a current game, and/or speed of rotation of a ball within said roulette wheel during a current game.

3. Apparatus according to claim 1, wherein said game data comprises time stamp data derived from a clock associated with the apparatus; or wherein said win calculation module is configured to:
receive time stamp data derived from a clock associated with the apparatus and said spin data;
calculate first data using said time stamp data and first spin data, and calculate second data using said time stamp data and second spin data; and
calculate said win data by entering said first and second data into a random number generator algorithm; and optionally wherein said first data and/or said second data comprises a randomly generated number.

4. Apparatus according to claim 1, wherein said video stream of said studio is captured with a single colour background; and optionally further comprising a graphics generating module for receiving said data representative of said one or more winning graphical elements and generating graphics data representative thereof for display on a screen of one or more of said remote user terminals together with said video stream; and optionally wherein said graphics data is superimposed into said displayed video stream.

5. Apparatus according to claim 4, wherein said graphics data is configured to generate an animated representation of said graphical elements; and optionally wherein graphics generating module is configured to receive spin data, indicative that said roulette wheel has started to spin, and, in response thereto, trigger said animated representation of said graphical elements for display on said screen; and optionally wherein said graphics generating module is configured to receive spin data indicative that a current game has ended and, in response thereto, cause said animated representation of said graphical elements displayed on said screen to stop.

6. Apparatus according to claim 4, wherein said graphics data is configured to display said graphical elements in the form of one or more slot reels that spin whilst said roulette wheel is spinning and stop at the end of a current game to indicate a winning graphical element.

7. A computer implemented method for facilitating online communication between a studio and a plurality of remote users, the method comprising:
providing a system clock;
using a communication module to transmit, to remote user terminals for display on respective screens thereof, a video stream of the studio from a camera in the studio, said video stream showing a roulette wheel and a croupier;
providing a user interface module configured to receive first bet instructions from a plurality of user terminals; and
using a processing module to display on a screen of one or more of said remote user terminals, together with said video stream, a plurality of graphical elements, said graphical elements having respective identity data associated therewith;
wherein said user interface module is further configured to receive a second bet instruction from said one or more of said plurality of remote user terminals in respect of a user-selected one or more of said graphical elements; the method further comprising:
using a win calculation module to receive spin data representative of at least one status of the roulette wheel during a current game and game data representative of a current game, and use said spin data and game data to calculate win data; and
using a win determination module to compare said win data with the identity data associated with said graphical elements to determine one or more winning graphical elements, and output data representative of said one or more winning graphical elements.

8. A method of online communication between a studio and a plurality of remote users, the method comprising:
transmitting a first video stream of the studio to the remote users from a first camera in the studio;
presenting on the first video stream a first side of a card, a second side of the card being hidden;
receiving a reveal instruction sent by an instructing one of the plurality of users; and
in response to the reveal instruction, revealing a portion of the second side of the card to the instructing user in a second video stream transmitted to the instructing user from a second camera in the studio.

9. The method of claim 8 wherein a first control function enabling the instructing user to send the reveal instructions is made available only to the instructing user; and optionally wherein each of the plurality of users select a bid amount prior to the card being presented on the first video stream; and optionally, wherein the instructing user is selected from the plurality of users based on the highest bid amount from the bid amounts selected by the plurality of users.

10. The method of claim 8, wherein the reveal instruction sent by the instructing user indicates how much of the second side of the card is revealed on the second video stream; and/or wherein a second control function enabling the instructing user to send a further instruction is made available only to the instructing user after the reveal instruction is sent to the instructing user; and optionally wherein the second side of the card is revealed to the plurality of users on the first video stream either in response to the further instruction being sent by the instructing user or after a predefined period of time has elapsed.

11. A method of online communication between a studio and a plurality of remote users, the method comprising:
transmitting a video stream of the studio to the remote users from a camera in the studio, the video stream showing a roulette wheel and a croupier;
receiving bet instructions from the plurality of users;
receiving a spin instruction sent by an instructing one of the plurality of users; and in response to the spin instruction, spinning a ball in the roulette wheel.

12. The method of claim 11, wherein a spin control function enabling the instructing user to send a spin instruction is made available only to the instructing user.

13. The method of claim 12, wherein the instructing user is selected from the plurality of users based on a number of games played by each of the plurality of users during a preceding time period, or wherein the instructing user is selected from the plurality of users based on a highest bid amount from previous bid instructions received from the plurality of users; and optionally wherein the highest bid amount is calculated over a predefined number of previous games played; or wherein the instructing user is selected from the plurality of users based on a player with the highest total winnings from one or more previous games.

14. The method of claim 14, wherein the instructing user is allocated a bonus in the event of a winning bet instruction being received from the instructing user; and optionally wherein the bonus is a proportion of an amount bid in the bet instruction received from the instructing user.

15. The method of any of claim 11, wherein a predefined time period is allowed for receiving the spin instruction.
